(19) United States
(12) Patent Application Publication
(10) Pub. No.: US 2021/0252682 A1
(43) Pub. Date: Aug. 19, 2021

(54) FASTENING TOOL INSTANT TORQUE METERING ACCESSORY

(71) Applicant: Enrico FASSIO, Roma (IT)

(72) Inventor: Enrico FASSIO, Roma (IT)

(21) Appl. No.: 17/251,823

(22) PCT Filed: Jun. 11, 2019
(86) PCT No.: PCT/IT2019/050133

§ 371 Date: Dec. 14, 2020

(30) Foreign Application Priority Data
Jun. 21, 2018 (IT) 102018000006565

(51) Int. Cl. B25B 23/142

(52) U.S. Cl. CPC B25B 23/1425

(57) ABSTRACT

The invention pertains to the field of manual fastening tools The invention is an accessory to most fastening tools, of any length and size: when coupled to the handle of the fastening tool of choice by means of a quick adaptive coupling system, the device's electronics will show on a digital display the instant torque resulting from the sensed applied force and its measured specific arm. The display's touch screen allows entry of Calibration data, target torque values, force arm length alternate entry, and selection of measuring unit.

### TECHNICAL FIELD: MANUAL TOOLS

In the field of manual mechanical tools, torque wrenches are tools used to apply a specific torque to a rotary fastener.

### BACKGROUND ART

Manual torque wrenches are usable within a torque range of a few tens of Nm; these tools are made of a tubular metal body showing at the two ends, respectively, a handle and the connection fitting for various socket types and sizes. When operated, a torque wrench will give a visual indication, an aural indication, or a combination thereof when the preset torque is reached; tools equipped with a digital display will permanently show the current applied torque value.

Below is a partial list of the limits of existing torque wrenches.
In order to withstand the mechanical stresses it is subject to, when operated close to the upper end of its torque range, a torque wrench is obviously oversized with regard to the lower end of said range.
A torque range of only a few tens of Nm does not meet the requirements of any automotive workshop, where application of torques ranging anywhere from 10 to 350 Nm is frequent; therefore at least two different torque wrenches are required.
The shape and size of existing torque wrenches are often incompatible with narrow spaces, such as the engine compartment of a car.
Click torque wrenches do not provide indication of the current torque value but only provide a click signal when the preset torque value is reached. Furthermore, a noisy environment might hide the click signal, which could result in excessive mechanical stress on the fastener. This over tightening condition does not happen with electronic torque wrenches, provided that the wrench's sensorial alerts are effective or that the digital screen is always visible to the operator.
Manual torque wrenches internal mechanism never allows torque to exceed the torque range; consequently, the application of a cheater bar only reduces the operator's effort.
Proper storage of mechanical wrenches requires that load is relieved from internal spring.
Calibration of torque wrenches require complex procedures and/or expensive equipment.

Disclosure of invention: The primary purpose of the invention is to provide the great variety of fastening tools of choice with the capability of measuring applied torque, by means of a single device that can be coupled as an accessory to any of said tools in order to measure the applied torque and to show its value on a digital display. The device is meant to be placed between the hand of the operator and any fastening tool, to which the device has been coupled, so that all the force applied by the operator is entirely transferred to the tool.

Another purpose of the invention is to calculate the applied torque by electronically and directly measuring both its components: the force and its lever arm

Another purpose of the invention is a versatile coupling system which allows the device to be easily joined to a small spanner or a long lever.

Another purpose of the invention are the device's extremely small dimensions which, not significantly altering the hosting tool overall dimensions, does not preclude its use in restricted spaces.

Another purpose of the invention is to allow a continuous control of the current torque by means of a digital display that, being not rigidly connected to the device, remains always visible to the operator.

Another purpose of the invention is a torque measuring instrument which is simple, light and small so that production and transport costs are significantly lower than what the market currently offers.

Another purpose of the invention is the simplicity of the calibration procedures that do not require special equipment and/or specific skills.

All these and other objects which will result from the following description are reached, according to the invention, with a device as characterized in the claims.

### BRIEF DESCRIPTION OF DRAWINGS

on page 1/2 FIG. 1 shows an exploded view of the device;

on page 2/2 FIG. 2 shows the cross section of a typical round spring to be used for round handles;

FIG. 3 shows a cross section of a typical spring to be used with flat tools (such as a spanner).

### BEST MODE FOR CARRYING OUT THE INVENTION

The present invention is hereafter further clarified, in a preferred embodiment thereof, given purely by way of non-limiting example, with reference to the attached drawings, that do not include those parts and/or unessential details of the device whose textual description renders the graphic representation unnecessary.

The device main components are:
a sensing unit, consisting of a force sensing unit and an arm measuring unit;
a quick connection system;
a processing and control unit. The sensing unit is coupled to the fastening tool by means of the quick connection system; it gathers electronic information relative to the force intensity and the measure of its lever arm; such signals are fed to the processing unit, to be then displayed on
a digital screen. Power to all electronic components is supplied by a
battery. In detail:

Force sensing unit: a metal barrette (hand-side bar) (1) is bolted to one end of a load cell (2). On the opposite side of the cell a shorter barrette (tool-side bar) (3) is bolted to the other end of said cell. Four electric wires connect the cell to an electronic circuit on a PCB. The load cell allows to measure the force applied to the hand-side bar and transferred to the tool-side bar.

Arm measuring unit: a laser diode and its circuitry on said PCB allows to measure the distance from a reference line on the force sensing unit to the axis of the fastener (bolt, nut, etc.).

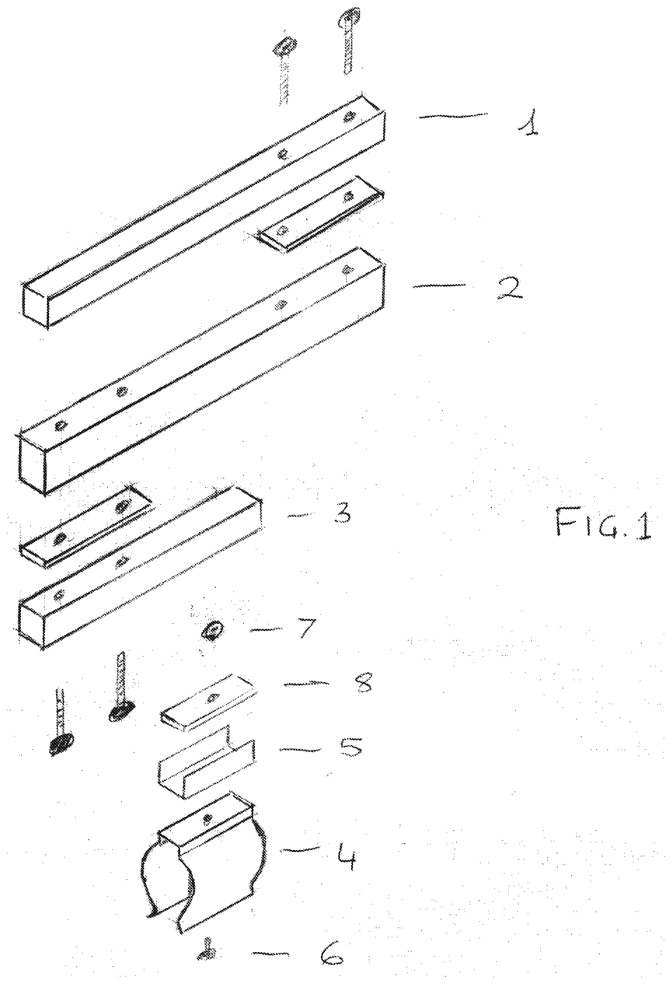

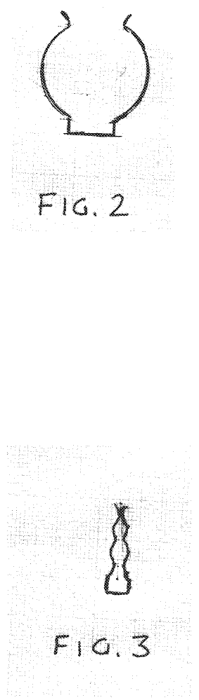

The quick connection system allows coupling of the sensing unit to the fastening tool so that the entire force participates in generating fastening torque. The system comprises: carbon steel springs (4) of various shape and size to couple the device to the different, in shape and size, fastening tools handles. FIG. 2 shows the cross section of a typical round spring to be used for round handles. FIG. 3 shows a cross section of a typical spring to be used with flat tools (such as a spanner). Each of these springs is bolted to a spring clip (5) that clamps on the tool-side bar. The head of the bolt (6), being the only contact point between the force sensing unit and the fastening tool, uniquely defines the point of application of the force, thus the possibility of measuring the force arm with precision. The nut (7) on the clip side is sunk in a fairing spacer (8) between the clip and the tool-side bar.

Electronic processing unit: a processor on an electronic board (PCB) receives signals from the force sensing unit and from the arm measuring unit and feeds them to a smartphone application by means of a Bluetooth Low Energy (BLE) module.

Power supply: a battery powers the Electronic processing unit.

Note: The Force sensing unit, the arm measuring unit, the Electronic processing unit and the battery are housed together in a plastic enclosure. A “window” in the enclosure allows the quick connection system clip to clamp the tool-side bar.

A dedicated Smartphone application allows Bluetooth pairing with the device. After positive connection is established, selection of the appropriate operating mode by means of the touchscreen, the display will show:

The lever arm, the value of which derives from the laser diode signal to the processing unit or is manually entered by the user;

the instantaneous force, applied by the user, as detected by the sensing element
the resulting instant torque, calculated by multiplying the force by its lever arm
the target torque, set by the user.

In general, by defining any two of the three values: lever arm, force, target torque, the third value is readily displayed.

In addition to these basic indications, data can be organized to provide any further desirable information, such as, for instance, the torque applied in sequence to the bolts of an engine head.

1) Device comprising at least one digital display on which the value of the torque produced by a force is shown, characterized:
by at least one sensor that detects the force intensity;
by at least one subsystem that measures the actual lever arm of such force, wherever its point of application and/or the pivot point are located
by at least an electronic processor unit that receives and processes the information from said sensor and said subsystem, computes the resulting torque and shows its value on said digital display.
by at least an input device that allows the operator to enter known and target values and to select the preferred measuring units.

2) Device according to claim 1, characterized in that said digital screen is not rigidly connected to said device.

3) Device according to one or more of the preceding claims, characterized by a coupling system which allows it to be rigidly attached to a fastening tool in a position such that the intensity of the force acting on said fastening tool is entirely detected by said electronic force sensor.

4) Device according to one or more of the preceding claims, the coupling system of which is characterized by at least one spring clamp able to effectively join together in a stable relative position said device and said tool;

5) Device according to one or more of the preceding claims whose coupling system is characterized by the possibility of selecting the spring clamp that best matches the size of the fastening tool handle.

6) Device according to claim 1 whose electronic processing unit is characterized in that it is equipped with a communication port for system upgrade and electronic components calibration.
